(19) United States
(12) Patent Application Publication
(10) Pub. No.: US 2026/0205950 A1
(43) Pub. Date: Jul. 16, 2026

(54) WIRELESS DEVICE AND METHOD OF SAVING POWER IN WIRELESS DEVICE

(71) Applicant: NEWRATEK Inc., Seoul (KR)

(72) Inventors: Joonsoo LEE, Irvine, CA (US); Hyun Sik JUNG, Irvine, CA (US); Junyoun WON, Irvine, CA (US); Sangwon KI, Irvine, CA (US); Hyungu PARK, Irvine, CA (US)

(21) Appl. No.: 19/433,191

(22) Filed: Dec. 26, 2025

(30) Foreign Application Priority Data
Jan. 10, 2025 (KR) 10-2025-0004308

(51) Int. Cl. H04W 52/02

(52) U.S. Cl. CPC H04W 52/0235; H04W 52/028

(57) ABSTRACT

A wireless device includes a processor configured to generate transmission data or process reception data, a main transceiver configured to transmit the transmission data or receive the reception data, and a WUR module configured to wake up at a wakeup time notified by an AP, receive a wakeup signal from the AP, and wake up the main transceiver based on a wakeup ID of the wireless device being included in the wakeup signal.

### CROSS-REFERENCE TO RELATED APPLICATION

This application is based on and claims priority under 35 U.S.C. § 119 to Korean Patent Application No. 10-2025-0004308 filed on January 10, 2025 in the Korean Intellectual Property Office, the disclosure of which is incorporated by reference herein in its entirety.

### BACKGROUND

### (a) Field

The disclosure relates to a wireless device and a method of saving power saving in the wireless device.

### (b) Description of the Related Art

A wireless communication system such as a wireless local area network (LAN) performs an operation of reducing power consumption by allowing a wireless device to enter a low-power mode (e.g., a sleep mode or a doze mode) when data transmission is not required, in order to save power of the wireless device. In the low-power mode, a wakeup duty cycle is defined, and a process in which the wireless device periodically wakes up to check whether there is data to be transmitted or received is repeatedly performed. The longer the cycle of entering the low-power mode and then waking up, the higher the probability that data to be transmitted to the wireless device will not be properly received. On the other hand, the shorter the cycle, the more frequently the operations of waking up and then entering the low-power mode are performed, so the effect of power consumption reduction is relatively reduced. In order to overcome such a trade-off, recent wireless LANs are attempting to increase the power reduction effect by introducing a wake-up radio (WUR) concept.

A WUR module may operate as a separate device or logic distinguished from a main transceiver of the wireless device. Alternatively, the WUR module may be configured as a part of a main wireless radio system. The main transceiver having the WUR module reduces basic power consumption by maintaining the entire system except for the WUR module in a low-power state. Assuming a situation in which a peer device intends to send data to a counterpart device, the peer device transmits a predefined wireless signal to the WUR module of the counterpart device. When the predefined wireless signal is received by the WUR module, the WUR module changes the main transceiver, which is in the low-power state, to a wakeup state.

In a conventional wireless device, because the WUR module always maintains the wakeup state to wake up the main transceiver, power consumption may occur in the WUR module. Therefore, it is necessary to save power of the WUR module in an ultra low-power device.

### SUMMARY

Some embodiments may provide a wireless device and a power saving method thereof that can save power of a WUR module configured to wake up a main transceiver.

A wireless device according to some embodiments may include a processor configured to generate transmission data or process reception data, a main transceiver configured to transmit the transmission data or receive the reception data, and a wakeup radio WUR module configured to wake up at a wakeup time notified by an access point (AP), receive a wakeup signal from the AP, and wake up the main transceiver based on a wakeup identifier (ID) of the wireless device being included in the wakeup signal.

A wireless device according to some embodiments may include a processor configured to determine a wakeup window including a wakeup time indicating a time to wake up a WUR module configured to wake up a main transceiver of a station and a time margin formed before and after the wakeup time, and a transceiver configured to transmit the wakeup time to the station, and transmit a wakeup signal a predetermined number of times during the wakeup window, the wakeup signal including a wakeup ID indicating the station and a wakeup duration indicating a time for the WUR module of the station to wake up the main transceiver.

According to some embodiments, a power saving method of a wireless device including a main transceiver and a WUR module configured to wake up the main transceiver may be provided. The method may include entering a low-power state in the main transceiver and the WUR module, performing a wakeup in the WUR module at a wakeup time notified by an access point (AP) and then receiving a wakeup signal from the AP, and waking up the main transceiver by the WUR module based on a wakeup ID of the wireless device being included in the wakeup signal.

### BRIEF DESCRIPTION OF THE DRAWINGS

FIG. 1 is a schematic block diagram illustrating a structure of a wireless device according to an embodiment.

FIG. 2 is a schematic block diagram illustrating a transmission signal processing unit shown in FIG. 1.

FIG. 3 is a schematic block diagram illustrating a reception signal processing unit shown in FIG. 1.

FIG. 4 is a diagram illustrating a wakeup signal of a wireless communication system according to an embodiment.

FIG. 5 is a diagram illustrating a wireless communication network according to an embodiment.

FIG. 6 is a flowchart illustrating a power saving method of a wireless device according to an embodiment.

FIG. 7 is a diagram illustrating a beacon frame of a wakeup signal according to an embodiment.

FIG. 8 is a diagram illustrating a wakeup frame of a wakeup signal according to an embodiment.

FIG. 9 is a diagram illustrating an operation in a wakeup window in a power saving method according to an embodiment.

FIG. 10 is a diagram illustrating an operation in a wakeup interval in a power saving method according to an embodiment.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps, and/or operations, these terms are only used to distinguish one element, component, step, or operation from another element, component, step, or operation.

In a wireless communication system, for example, a wireless LAN, a basic service set (BSS) may include a plurality of wireless devices. The wireless device may include a medium access control (MAC) layer and a physical (PHY) layer according to the IEEE (institute of electrical and electronics engineers) standard 802.11. Among the plurality of wireless devices, at least one wireless device may be an access point (AP), and the remaining wireless devices may be non-AP stations (non-AP STAs). Alternatively, all of the plurality of wireless devices may be non-AP STAs in ad-hoc networking. In general, the STA may be also used to collectively refer to the AP and the non-AP STA, but for convenience, the non-AP STA will be abbreviated as the STA.

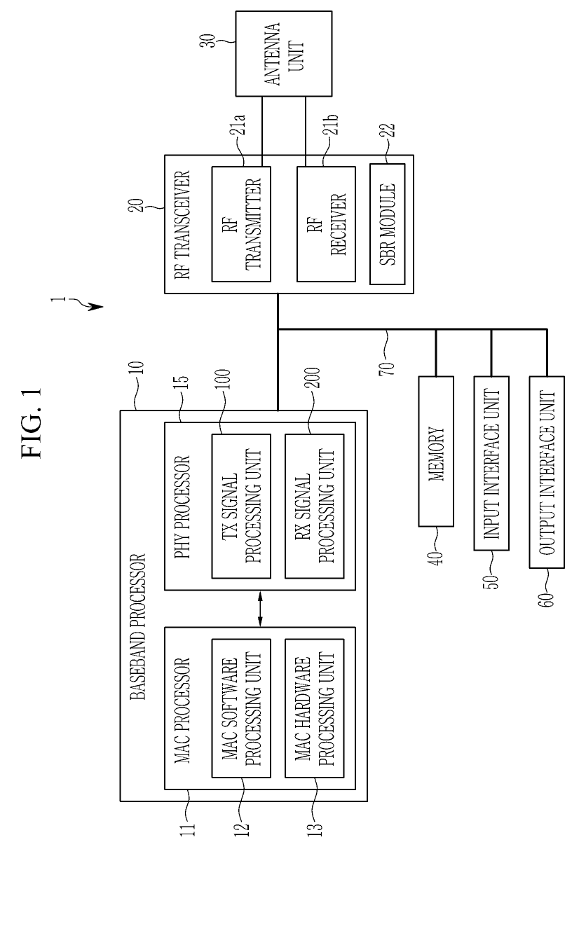

FIG. 1 is a schematic block diagram illustrating a structure of a wireless device according to an embodiment.

Referring to FIG. 1, a wireless device 1 includes a baseband processor 10, a radio frequency (RF) transceiver 20, an antenna unit 30, a memory 40, an input interface unit 50, an output interface unit 60, and a bus 70.

The baseband processor 10 performs baseband-related signal processing, and may include a MAC processor 11 and a PHY processor 15. In some embodiments, the baseband processor 10 may generate transmission data or process reception data. In some embodiments, the baseband processor 10 may determine a wakeup interval, a wakeup time, and a wakeup window, which will be described below. In some embodiments, the baseband processor 10 may generate a wakeup signal, which will be described below.

In some embodiments, the MAC processor 11 may include a MAC software processing unit 12 and a MAC hardware processing unit 13. The memory 40 may include software including some functions of the MAC layer (hereinafter referred to as “MAC software”), the MAC software processing unit 12 may execute the MAC software to implement some functions of the MAC layer, and the MAC hardware processing unit 13 may implement the remaining functions of the MAC layer as hardware (hereinafter referred to as “MAC hardware”), but it is not limited thereto.

The PHY processor 15 includes a transmission (TX) signal processing unit 100 and a reception (RX) signal processing unit 200.

The baseband processor 10, the memory 40, the input interface unit 50, and the output interface unit 60 may communicate with each other through the bus 70.

The RF transceiver 20 includes a main transceiver 21 and a wakeup radio (WUR) module (alternatively, WUR circuitry) 22. The main transceiver 21 includes an RF transmitter 21a and an RF receiver 21b, and transmits or receives an RF signal through the antenna unit 30. The WUR module 22 may be a device or logic that operates separately from the main transceiver 21. When receiving a wakeup signal, the WUR module 220 wakes up the main transceiver 21, which is in a low-power state, in response to the wakeup signal. In some embodiments, the WUR module 220 may perform a WUR function defined in the IEEE 802.11ba standard. The WUR module 220 uses a power saving protocol that transitions between a low-power state and a wakeup state for aggressive power saving. Hereinafter, the WUR module 22 that enables power saving by transitioning the WUR to the low-power state periodically while performing the function of the WUR is referred to as a standby radio (SBR) module (alternatively, SBR circuitry) 22.

The memory 40 may store an operating system, an application, etc. in addition to the MAC software. The input interface unit 50 acquires information from a user, and the output interface unit 60 outputs information to the user.

The antenna unit 30 includes one or more antennas. When using multiple-input multiple-output (MIMO) or multi-user MIMO (MU-MIMO), the antenna unit 30 may include a plurality of antennas.

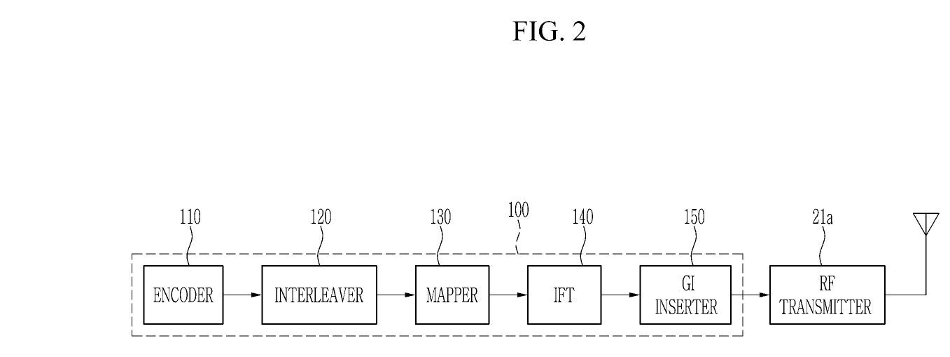

FIG. 2 is a schematic block diagram illustrating a transmission signal processing unit shown in FIG. 1.

Referring to FIG. 2, a transmission signal processing unit 100 includes an encoder 110, an interleaver 120, a mapper 130, an inverse Fourier transformer (IFT) 140, and a guard interval (GI) inserter 150.

The encoder 110 encodes input data and may be, for example, a forward error correction (FEC) encoder. The FEC encoder may include a binary convolutional code (BCC) encoder followed by a puncturing device. Alternatively, the FEC encoder may include a low-density parity-check (LDPC) encoder.

The transmission signal processing unit 100 may further include a scrambler that scrambles the input data before encoding to reduce the probability of long identical sequences of 0s or 1s. If a plurality of BCC encoders are used as the encoder 110, the transmission signal processing unit 100 may further include an encoder parser for demultiplexing scrambled bits to the plurality of BCC encoders. If the LDPC encoder is used as the encoder 110, the transmission signal processing unit 100 may not use the encoder parser.

The interleaver 120 interleaves bits of a stream output from the encoder 110 to change an order of bits. Interleaving may be applied only when the BCC encoder is used as the encoder 110. The mapper 130 maps a sequence of bits output from the interleaver 120 to constellation points. If the LDPC encoder is used as the encoder 110, the mapper 130 may further perform LDPC tone mapping in addition to the constellation mapping.

When using the MIMO or the MU-MIMO, the transmission signal processing unit 100 may use a plurality of interleavers 120 and a plurality of mappers 130 corresponding to the number of spatial streams (N_{SS}). In this case, the transmission signal processing unit 100 may further include a stream parser that divides outputs of the plurality of BCC encoders or LDPC encoder into a plurality of blocks to be provided to different interleavers 120 or mappers 130. In addition, the transmission signal processing unit 100 may further include a space-time block code (STBC) encoder that spreads the constellation points from N_{SS} spatial streams to N_{STS} space-time streams and a spatial mapper that maps space-time streams to transmit chains. The spatial mapper may use a method such as direct mapping, spatial expansion, or beamforming.

The inverse Fourier transformer 140 transforms a constellation point block output from the mapper 130 or the spatial mapper into a time domain block, i.e., a symbol, using an inverse discrete Fourier transform (IDFT) or an inverse fast Fourier transform (IFFT). When the STBC encoder and the spatial mapper are used, the inverse Fourier transformer 140 may be provided for each transmit chain.

When using the MIMO or the MU-MIMO, the transmission signal processing unit may insert cyclic shift diversity (CSD) before or after the inverse Fourier transform to prevent unintended beamforming. CSD may be specified for each transmit chain or for each space-time stream. Alternatively, CSD may be applied as part of the spatial mapper.

In addition, when using MU-MIMO, some blocks before the spatial mapper may be provided for each user.

The GI inserter 150 inserts a GI in front of a symbol. The transmission signal processing unit 100 may perform windowing to smooth the edges of the symbol after inserting the GI. The RF transmitter 21 converts the symbol into an RF signal and transmits it through an antenna. When using MIMO or MU-MIMO, the GI inserter 150 and the RF transmitter 21 may be provided for each transmit chain.

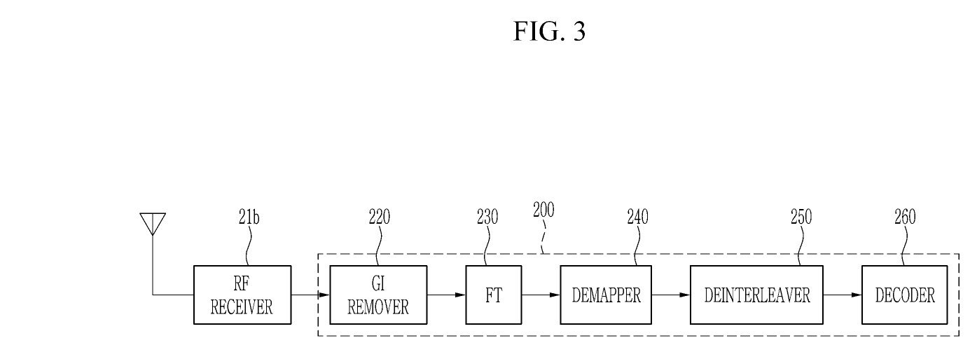

FIG. 3 is a schematic block diagram illustrating a reception signal processing unit shown in FIG. 1.

Referring to FIG. 3, a reception signal processing unit 200 includes a GI remover 220, a Fourier transformer (FT) 230, a demapper 240, a deinterleaver 250, and a decoder 260.

The RF receiver 22 receives an RF signal through an antenna and converts the RF signal into a symbol, and the GI remover 220 removes a GI from the symbol. When using MIMO or MU-MIMO, the RF receiver 22 and the GI remover 220 may be provided for each receive chain.

The Fourier transformer 230 transforms a symbol, i.e., a time domain block, into a constellation point in a frequency domain using a discrete Fourier transform (DFT) or a fast Fourier transform (FFT). The Fourier transformer 230 may be provided for each receive chain.

When using MIMO or MU-MIMO, the receiving signal processing unit 200 may include a spatial demapper that converts the Fourier-transformed receive chain into constellation points of a space-time stream and an STBC decoder that despreads the constellation points from the space-time stream to a spatial stream.

The demapper 240 demaps the constellation point block output from the Fourier transformer 230 or the STBC decoder into a bit stream. If the received signal is LDPC encoded, the demapper 240 may further perform LDPC tone demapping before constellation demapping. The deinterleaver 250 deinterleaves bits of the stream output from the demapper 240. Deinterleaving may be applied only when the received signal is BCC encoded.

When using MIMO or MU-MIMO, the reception signal processing unit 200 may use a plurality of demappers 240 and a plurality of deinterleavers 250 corresponding to the number of spatial streams. In this case, the reception signal processing unit 200 may further include a stream deparser that combines the streams output from the plurality of deinterleavers 250.

The decoder 260 decodes the stream output from the deinterleaver 250 or the stream deparser, and may be, for example, an FEC decoder. The FEC decoder may include a BCC decoder or an LDPC decoder. The reception signal processing unit 200 may further include a descrambler that descrambles the data decoded by the decoder 260. If a plurality of BCC decoders are used as the decoder 260, the reception signal processing unit 200 may further include an encoder deparser that multiplexs the decoded data. If an LDPC decoder is used as the decoder 260, the reception signal processing unit 200 may not use the encoder deparser.

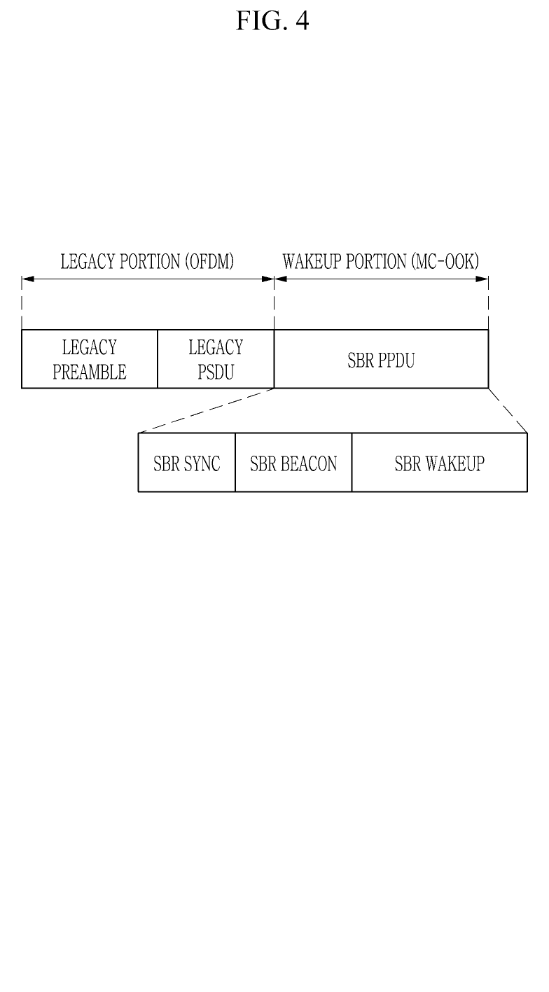

FIG. 4 is a diagram illustrating a wakeup signal of a wireless communication system according to an embodiment.

Referring to FIG. 4, a wakeup signal includes a legacy part and a wakeup part.

The legacy part is a part that supports a legacy wireless communication system (e.g., a legacy wireless LAN) and includes a legacy preamble. The wireless LAN is being standardized in IEEE Part 11. After the original standard has been released in 1999, new versions of the standard are continuously being released through amendments. The IEEE 802.11a standard (IEEE Std 802.11a-1999) supporting the 5 GHz band and the IEEE 802.11b standard (IEEE Std 802.11b-1999) supporting the 2.4 GHz band have been released in 1999, and the IEEE 802.11g standard (IEEE Std 802.11g-2003) supporting the 2.4 GHz band has been released in 2003, and these standards are called legacy. In some embodiments, the legacy preamble may include a legacy short training field (L-STF), a legacy long training field (L-LTF), and a legacy signal field (L-SIG). In some embodiments, the legacy part may further include a legacy data field (e.g., a legacy PSDU (PLCP (physical layer convergence protocol) service data unit)) following the legacy preamble.

The wakeup part may be a PPDU (PLCP protocol data unit) and may include a plurality of frames. The plurality of frames may include at least one of a synchronization (sync) frame, a beacon frame, or a wakeup frame. Hereinafter, the synchronization frame is referred to as an SBR synchronization frame, the beacon frame as an SBR beacon frame, and the wakeup frame as an SBR wakeup frame.

In the wakeup signal, the legacy part and the wakeup part use different modulation schemes. In general, the legacy part uses orthogonal frequency division multiplexing (OFDM), but the wakeup part uses a simple modulation for low-power devices. In some embodiments, the wakeup part may use on-off keying (OOK), for example, multicarrier OOK (MC-OOK). If a wireless device not equipped with an SBR module receives a wakeup signal having only a wakeup part modulated with MC-OOK, the wireless device cannot interpret the wakeup signal, so a wakeup signal with the legacy part attached before the wakeup part is used. The SBR synchronization frame of the wakeup part may include a synchronization sequence for synchronization of the OOK-modulated wakeup part.

A legacy wireless device that has received the wakeup signal can normally interpret the legacy preamble, and thus can protect duration in which the wakeup part is transmitted through information included in the signal field (L-SIG) of the legacy preamble. Alternatively, the legacy wireless device can protect the duration in which the wakeup part is transmitted through MAC duration information obtained from the legacy PSDU.

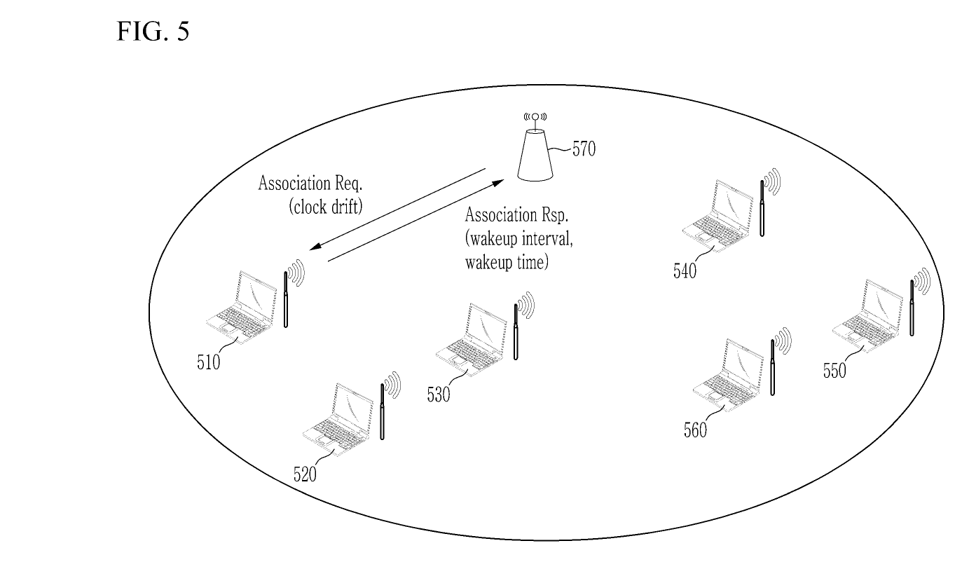

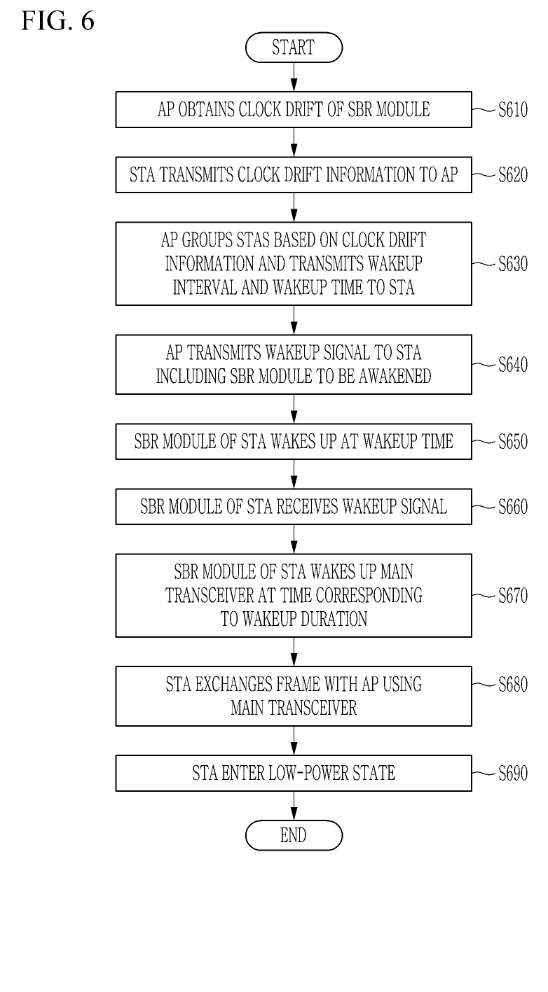

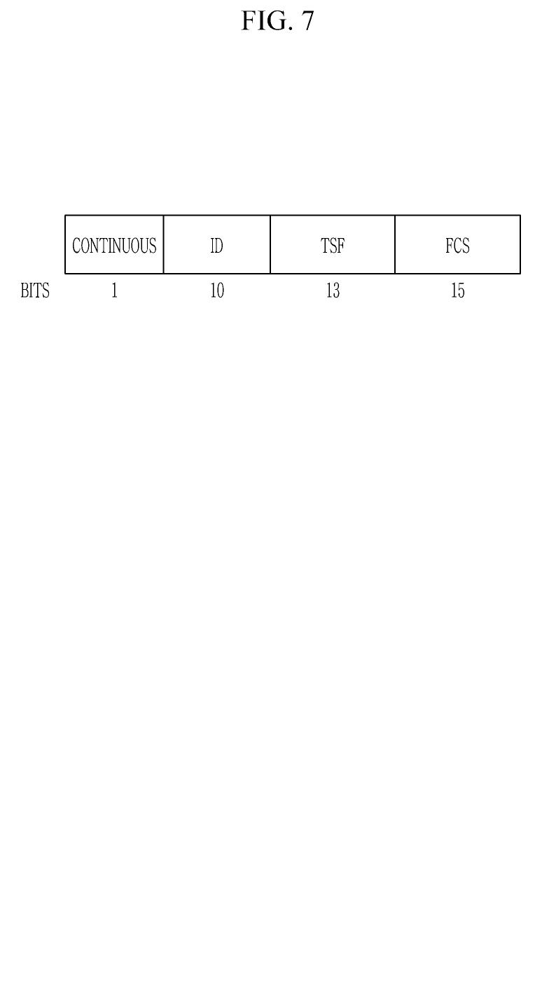

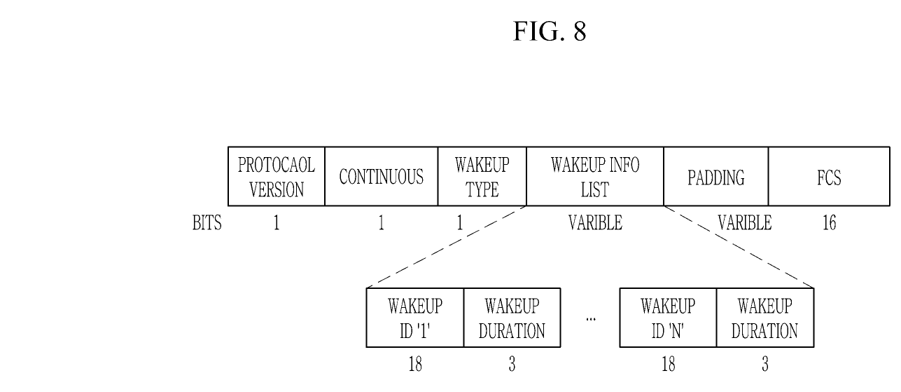

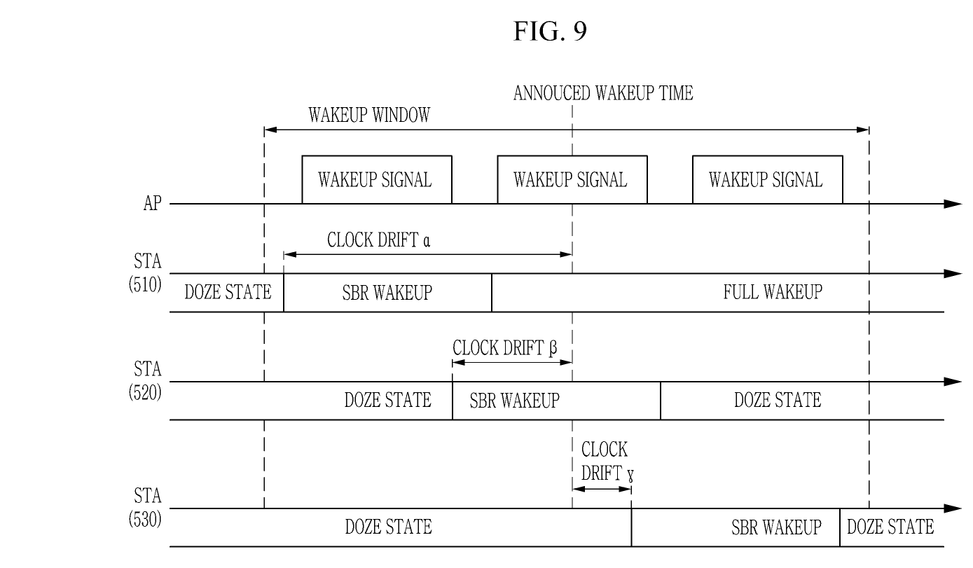

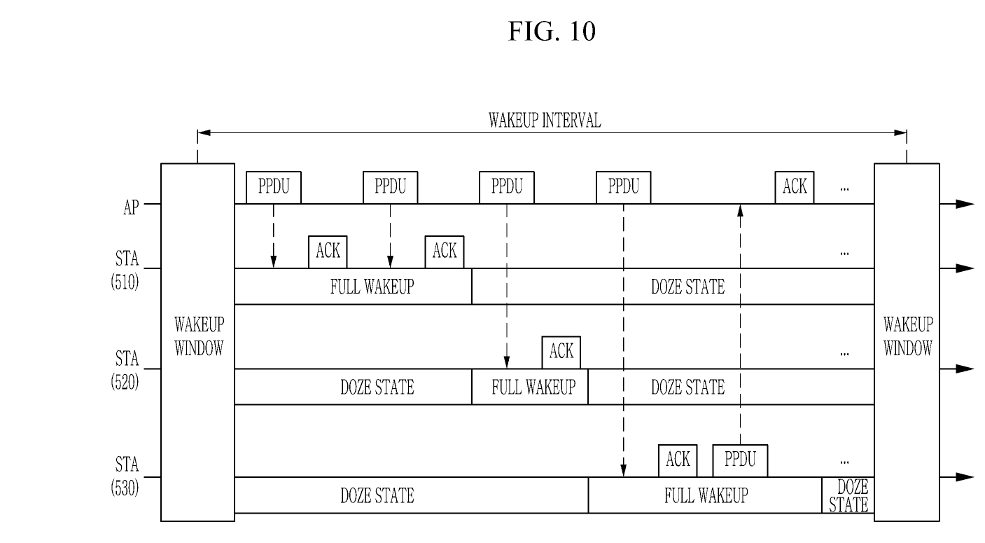

FIG. 5 is a diagram illustrating a wireless communication network according to an embodiment, and FIG. 6 is a flowchart illustrating a power saving method of a wireless device according to an embodiment. FIG. 7 is a diagram illustrating a beacon frame of a wakeup signal according to an embodiment, and FIG. 8 is a diagram illustrating a wakeup frame of a wakeup signal according to an embodiment. FIG. 9 is a diagram illustrating an operation in a wakeup window in a power saving method according to an embodiment, and FIG. 10 is a diagram illustrating an operation in a wakeup interval in a power saving method according to an embodiment.

Referring to FIG. 5, to wake up a main transceiver (e.g., 21 of FIG. 1) of a wireless device (e.g., STA) 510 in a low-power state, a wireless device (e.g., AP) 570 associated with the STA 510 transmits a wakeup signal to the STA 510.

Because an SBR module (e.g., 22 of FIG. 1) of the STA 510 performs a function related to demodulation of a simple signal, an accuracy of an operating clock speed and a pulse generator that generates a pulse are low. While a clock drift of a general wireless device is at a level of several tens of ppm (parts per million), the SBR module 22 may have a clock drift at a level of several hundreds of ppm. When the SBR module 22 enters a low-power state (e.g., a doze state) for power saving and then wakes up, a considerable error may occur between a timer value held by the associated AP 570 and a timer value held by the SBR module 22. This error may be further accumulated to have a large value as a cycle of entering the low-power state and then waking up becomes longer. In other words, the SBR module 22 of the STA 510 and the AP 570 may look at different time values.

For example, it is assumed that after the SBR module 22 is updated with a TSF (time synchronization function) timer value of the AP 570, the SBR module 22 enters the low-power states and then wakes up after X ms (milliseconds). If the TSF timer value that the AP 570 actually has is a reference point + X ms, the TSF timer of the SBR module 22 does not have the corresponding value due to the clock drift, so it may wake up much later or much earlier than X ms. Because the clock drift in the SBR module 22 is large, if the SBR module 22 enters the low-power state for a long time, the error in the TSF timer value with the AP 570 may become even larger. Accordingly, after waking up from the low-power state, the SBR module 22 must be in a reception standby state for a longer time than expected in order to receive a signal from the AP 570. That is, because the signal to be received from the AP 570 has already passed or there is still time until the AP 570 actually transmits the signal, a long reception standby state may be required.

Hereinafter, embodiments of a power saving method that can reduce the inefficiency caused by the clock drift are described.

Referring to FIGS. 5 and 6, a wireless device (e.g., STA) 510 including an SBR module (e.g., 22 of FIG. 1) obtains a clock drift of the SBR module 22 (S610). In some embodiments, the STA 510 may measure the clock drift based on a difference between a main reference clock that operates a main transceiver (e.g., 21 of FIG. 1) and an operating clock of the SBR module 22. In some embodiments, the STA 510 may measure the clock drift based on a packet round trip time (RTT) with a wireless device (e.g., AP) 570 with which the STA 510 is associated. In some embodiments, the clock drift may be stored in the SBR module 22, and the STA 510 may obtain the clock drift stored in the SBR module 22. Similarly, other STAs 520, 530, 540, 550, and 560 may also obtain the clock drifts of their own SBR modules.

Each of the STAs 510 to 560 transmits information including the clock drift to the AP 570 (S620). In some embodiments, each of the STAs 510 to 560 may report the information to the AP 570 through an association process (e.g., through an association request frame) or through a periodic update frame. FIG. 5 illustrates a process in which the STA 510 transmits clock drift information to the AP 570 through the association request frame.

The AP 570 groups the STAs 510 to 560 based on the clock drift information (S630). In some embodiments, the AP 570 may transmit information about a wakeup interval and a wakeup time to the STAs of each group (S630). The wakeup interval is a period in which an STA performs a procedure according to wakeup, and may be used to determine a wakeup window. The wakeup time is a start time of the wakeup interval and may indicate a time for the SBR module 22 of the STA to wake up. In this case, the wakeup window may include time margins formed before and after the wakeup time. In some embodiments, the AP 570 may transmit the information to each of the STAs 510 to 560 through the association process (e.g., through the association response frame) or through the periodic update frame.

Once the wakeup interval is determined, the AP 570 may set the wakeup window in the wakeup interval based on the clock drift. The same wakeup window may be set for the STAs (e.g., the STAs 510, 520, and 530) of the same group. The wakeup window may mean a time range in which the SBR modules 22 of the STAs 510, 520, and 530 of the same group can actually wake up due to the clock drift. For example, if the clock drift is 100 ppm and the wakeup interval is 10 seconds, the wakeup window may be a time window of ±1 ms from the wakeup time.

As described above, as a wakeup interval of a device with a large clock drift becomes longer, errors may accumulate, so a wider wakeup window may be required. The AP 570 may transmit the wakeup signal several times within the wakeup window so that the STAs 510 to 560 can properly listen the wakeup signal. In this case, the AP 570 may not set the wakeup interval excessively long so that the wakeup window is not set too long. In addition, by limiting the maximum number of times the AP 570 transmits the wakeup signal during the wakeup window, it can be prevented that the SBR module 22 waits for the wakeup signal for too long compared to the actual wakeup time. That is, the AP 570 may define the wakeup interval for each STA group based on the clock drift of that group, thereby saving power of the SBR module 22 and preventing excessive channel occupation by the AP 570. The AP 570 may determine the wakeup interval considering these matters.

In some embodiments, different wakeup times may be scheduled for STA groups, or the wakeup times may be set to overlap according to periodicity.

The AP 570 transmits a wakeup signal to the STAs (e.g., STAs 510, 520, and 530 of FIG. 5) that include the SBR module 22 to be awakened among the plurality of STAs 510 to 560 (S640). The AP 570 may transmit the wakeup signal a predetermined number of times during the wakeup window. The wakeup signal, for example, a wakeup part of the wakeup signal, may include a TSF timer value, a wakeup identifier (ID), and a wakeup duration. The TSF timer value is a value for time synchronization between the AP 570 and the STA, the wakeup ID is an ID indicating an STA including the SBR module 22 to be awakened in response to the wakeup signal, and the wakeup duration is information about a duration in which the main transceiver (e.g., 21 of FIG. 1) of the STA corresponding to the wakeup ID is to wake up.

In some embodiments, as shown in FIG. 7, an SBR beacon frame of the wakeup signal may include a TSF field, and the TSF field may carry a TSF timer value. The TSF timer value may be expressed in units of, for example, 64 μs by lowering a resolution, and may have 13 bits [6:18]. In some embodiments, the SBR beacon frame may further include an ID field, and the ID field may carry the ID of the AP 570. In some embodiments, the SBR beacon frame may further include a continuous field, and the continuous field may carry a value indicating whether the corresponding frame is a continuous transmission. In some embodiments, the SBR beacon frame may further include a frame check sequence (FCS) field, and the FCS field may carry an FCS. For example, the continuous field, the ID field, and the FCS field may have 1 bit, 10 bits, and 16 bits, respectively.

In some embodiments, as shown in FIG. 8, an SBR wakeup frame of the wakeup signal may include a wakeup ID and a wakeup duration. The wakeup frame may include a wakeup information list field. The wakeup information list field may include at least one wakeup information pair, and each wakeup information pair may include a wakeup ID and a wakeup duration associated with the wakeup ID. For example, in cases where the STAs 510, 520, and 530 receive a wakeup signal and then wake up, the wakeup information list field may include a pair of an ID of the STA 510 and a duration in which the main transceiver 21 of the STA 510 is to wake up, a pair of an ID of the STA 520 and a duration in which the main transceiver 21 of the STA 520 is to wake up, and a pair of an ID of the STA 530 and a duration in which the main transceiver 21 of the STA 530 is to wake up.

In some embodiments, the SBR wakeup frame may further include at least one of a protocol version field, a continuous field, a wakeup type field, a padding field, and an FCS field. The protocol version field may carry a protocol version of the SBR wakeup frame, the wakeup type field may carry a wakeup type of the wakeup signal, and the padding field may include padding to adjust a length of the wakeup frame. For example, the wakeup ID field, the wakeup duration field, the protocol version field, the continuous field, the wakeup type field, and the FCS field may have 18 bits, 3 bits, 1 bit, 1 bit, 1 bit, and 16 bits, respectively. The wakeup information list field may be variable depending on the number of STAs to receive the wakeup signal, and the padding field may also be variable.

The SBR module 22 of the STA wakes up at the announced wakeup time (e.g., the wakeup time received in S630) (S650). A wakeup in which only the SBR module 22 wakes up is called an SBR wakeup. The SBR module 22 may wake up at a time determined by applying the clock drift to the wakeup time. In this case, even for STAs in the same group, they may wake up at different times due to the clock drift caused by the error between the internal timer of the SBR module 22 and the TSF timer of the AP 570. For example, as shown in FIG. 9, the SBR module 22 of the STA 510 may wake up from the low-power state at a time earlier than the wakeup time by α due to its own clock drift (clock drift α), the SBR module 22 of the STA 520 may wake up from the low-power state at a time earlier than the wakeup time by β due to its own clock drift (clock drift β), and the SBR module 22 of the STA 530 may wake up from the low-power state at a time later than the wakeup time by γ due to its own clock drift (clock drift γ). As described above, the AP 570 may set the wakeup window to include periods in which the SBR modules 22 of the STAs 510, 520, and 530 of the same group wake up based on the clock drifts of the STAs 510, 520, and 530, and may transmit the wakeup signal a predetermined number of times (e.g., 3 times) during the wakeup window (S640).

The SBR modules 22 of the STAs 510, 520, and 530 receive the wakeup signal during the awaken period (S660). Therefore, the SBR modules 22 of the STAs 510, 520, and 530 may receive at least one wakeup signal. Because the TSF timer value included in the wakeup signal has the TSF timer value of the AP 570 at the timing when the wakeup signal is transmitted, the TSF timer values included in the three wakeup signals do not have the same value. The SBR module 22 of each STA may achieve time synchronization with the AP 570 based on the TSF timer value of the received wakeup signal. Because the three wakeup signals have the same wakeup information list, the STAs 510, 520, and 530 of the same group may obtain the same wakeup information list.

The SBR module 22 of each of the STAs 510, 520, and 530, if its own wakeup ID is included in the wakeup information list of the received wakeup signal, interprets the wakeup duration assigned to the wakeup ID and wakes up the main transceiver 21 at a time corresponding to the wakeup duration (S670). A wakeup that wakes up the main transceiver 21 is called a full wakeup. As shown in FIGS. 9 and 10, because the SBR modules 22 of the STAs 520 and 530 wake up later than that of the STA 510 and receive the wakeup signal, the wakeup duration for the full wakeup of the STAs 520 and 530 may be set relatively later. For example, the STA 520 may perform the full wakeup based on its own wakeup duration after the wakeup duration of the STA 510 ends, and the STA 530 may perform the full wakeup based on its own wakeup duration after the wakeup duration of the STA 520 ends. In this case, the SBR modules 22 of the STAs 520 and 530 may re-enter the low-power state before performing the full wakeup, and then perform the full wakeup at the time set in the wakeup duration. As such, if the SBR module 22 wakes up, interprets the wakeup signal, and then re-enters the low-power state before waking up the main transceiver 21, power consumption can be saved. Meanwhile, in cases where the wakeup signal which the SBR module 22 of the STA receives after waking up does not include its own wakeup ID, the SBR module 22 may re-enter the low-power state.

The STA that has performed the full wakeup exchanges a frame with the AP 570 using the main transceiver 21 (S680). For example, the STA 510 may receive a PPDU from the AP 570 during a period specified in the wakeup duration after performing the full wakeup, and transmit an acknowledgement (ACK) to the received PPDU. Similarly, the STA 520 may receive a PPDU from the AP 570 during a period specified in the wakeup duration after performing the full wakeup, and transmit an ACK to the received PPDU. In cases where the STA 530 has data to be transmitted in uplink, the STA 530 may transmit a PPDU to the AP 570 during a period specified in the wakeup duration after performing the full wakeup, and receive an ACK to the PPDU. The STAs 510, 520, and 530 may re-enter the low-power state when there is no data to be transmitted/received or when the period specified in the wakeup duration has elapsed (S690). Then, the STAs 510, 520, and 530 may perform the SBR wakeup again at the negotiated wakeup time.

As described above, the SBR modules 22 of the STAs 510, 520, and 530 can save power consumed by the SBR modules 22 by periodically performing the low-power state and wakeup. In addition, the STAs 510, 520, and 530 can further save power by re-entering the low-power state after the SBR wakeup and before the full wakeup if their wakeup durations are set late.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A wireless device, comprising:
a processor configured to generate transmission data or process reception data;
a main transceiver configured to transmit the transmission data or receive the reception data; and
a wakeup radio (WUR) module configured to:
wake up at a wakeup time announced by an access point (AP),
receive a wakeup signal from the AP, and
wake up the main transceiver based on a wakeup identifier (ID) of the wireless device being included in the wakeup signal.

2. The wireless device of claim 1, wherein the WUR module is further configured to wake up the main transceiver at a time corresponding to a wakeup duration that is associated with the wakeup ID and included in the wakeup signal.

3. The wireless device of claim 2, wherein the WUR module is further configured to enter a low-power state until the time corresponding to the wakeup duration.

4. The wireless device of claim 1, wherein the main transceiver is further configured to obtain a clock drift of the WUR module and transmit information about the clock drift to the AP.

5. The wireless device of claim 4, wherein the main transceiver is further configured to receive the wakeup time from the AP after transmitting the information about the clock drift.

6. The wireless device of claim 1, wherein the wakeup signal includes a legacy part including a legacy preamble and a wakeup part including the wakeup ID, and
wherein the legacy part and the wakeup part are modulated in different modulations.

7. The wireless device of claim 6, wherein the legacy part is modulated with orthogonal frequency division multiplexing (OFDM), and the wakeup part is modulated with on-off keying (OOK).

8. The wireless device of claim 6, wherein the wakeup part further includes a synchronization frame for synchronization of the wakeup part.

9. The wireless device of claim 6, wherein the wakeup part further includes a beacon frame that carries a TSF (time synchronization function) timer value of the AP.

10. The wireless device of claim 6, wherein the wakeup part further includes a wakeup frame that carries a wakeup information list, and
wherein the wakeup information list includes the wakeup ID and a wakeup duration associated with the wakeup ID, and the wakeup duration indicates a period in which the WUR module of the wireless device indicated by the wakeup ID wakes up.

11. A wireless device, comprising:
a processor configured to determine a wakeup window including a wakeup time indicating a time to wake up a wakeup radio (WUR) module configured to wake up a main transceiver of a station and a time margin formed before and after the wakeup time; and
a transceiver configured to:
transmit the wakeup time to the station, and
transmit a wakeup signal a predetermined number of times during the wakeup window, the wakeup signal including a wakeup ID indicating the station and a wakeup duration indicating a time for the WUR module of the station to wake up the main transceiver.

12. The wireless device of claim 11, wherein the transceiver is further configured to receive information about a clock drift of the WUR module from the station, and
wherein the processor is further configured to determine the wakeup window based on the clock drift.

13. The wireless device of claim 11, wherein the transceiver is further configured to receive information about a clock drift of the WUR module of each station from a plurality of stations, and
wherein the processor is further configured to group the plurality of stations based on the clock drift, and set a same wakeup window for a same group.

14. The wireless device of claim 11, wherein the wakeup signal includes a legacy part including a legacy preamble and a wakeup part including the wakeup ID, and
wherein the legacy part and the wakeup part are modulated in different modulations.

15. The wireless device of claim 14, wherein the legacy part is modulated with orthogonal frequency division multiplexing (OFDM), and the wakeup part is modulated with on-off keying (OOK).

16. The wireless device of claim 14, wherein the wakeup part further includes a synchronization frame for synchronization of the wakeup part.

17. The wireless device of claim 14, wherein the wakeup part further includes a beacon frame that carries a TSF (time synchronization function) timer value of the wireless device.

18. The wireless device of claim 14, wherein the wakeup part further includes a wakeup frame that carries a wakeup information list, and
wherein the wakeup information list includes the wakeup ID and the wakeup duration.

19. A power saving method of a wireless device including a main transceiver and a wakeup radio (WUR) module configured to wake up the main transceiver, the method comprising:
entering a low-power state in the main transceiver and the WUR module;
performing a wakeup in the WUR module at a wakeup time announced by an access point (AP) and then receiving a wakeup signal from the AP; and
waking up the main transceiver by the WUR module based on a wakeup ID of the wireless device being included in the wakeup signal.

20. The method of claim 19, wherein the wakeup signal includes a wakeup duration associated with the wakeup ID, and
wherein the waking up the main transceiver includes waking up the main transceiver at a time corresponding to the wakeup duration.
